(19) United States
(12) Patent Application Publication
(10) Pub. No.: US 2006/0064757 A1
(43) Pub. Date: Mar. 23, 2006

(54) Method and system for user secure access to user content recordings

(76) Inventor: Thomas Poslinski, Elma, NY (US)

Correspondence Address: WAGNER, MURABITO & HAO LLP, Two North Market Street, Third Floor, San Jose, CA, 95113, US

(21) Appl. No.: 10/946,297

(22) Filed: Sep. 20, 2004

(51) Int. Cl. H04N 7/16

(52) U.S. Cl. 726/26

(57) ABSTRACT

Embodiments of the present invention recite a method and system for user secure access to user content recordings. The content recordings contain programs whose access is user-specific. In one embodiment, a particular user who is permitted access to an instance of restricted user-specific media content via a digital set-top box is identified. A user-specific list of media content accessible via the digital set-top box is presented. In embodiments of the present invention, the list comprises the instance of restricted user-specific media content accessible by said particular user. The particular user is then permitted to access the instance of restricted media via the digital set-top box.

### FIELD OF THE INVENTION

The present invention relates to the field of digital recording and playback. More specifically, embodiments of the present invention are directed to a method and system for accessing restricted media content in a user-centric media system.

### BACKGROUND OF THE INVENTION

A digital set-top box is a device that enables a television to become a user interface to the Internet and also enables a television to receive and decode digital television (DTV) broadcasts. A digital set-top box may also be used by television viewers who wish to use their current analog television sets to receive digital broadcasts. Digital set-top boxes are often referred to as digital video recorders (DVRs) and personal video recorders (PVRs). DVRs are devices that can record media content (e.g., television programming) using digital media (e.g., a hard disk or memory) rather than video tape.

A PVR performs the same functions as a DVR but has more features that allow the PVR to function as a multimedia center. Additional features commonly provided by PVRs include the ability to play games, watch picture slide shows, listen to music as well as being able to program the PVR to record media content based upon user defined parameters. For example, a user can provide the name of a television series and the PVR will record and store episodes of that series that are available. Other user defined parameters include the name of an actor, a director, or even a keyword.

A typical digital set-top box contains one or more digital processors for running its operating system and for parsing the MPEG transport stream of a digital broadcast. A digital set-top box may also include RAM, an MPEG decoder chip, and additional chips for audio decoding and processing. More sophisticated digital set-top boxes may also contain a hard drive for storing recorded television broadcasts, for downloaded software, and for other applications provided by a DTV service provider. Some digital set-top boxes may also include a writeable digital versatile disk drive (e.g., a DVD R/W drive) to facilitate creating copies of broadcast content.

Typically, PVR and DVR equipped digital set-top boxes are content centric. In other words, the content stored upon the hard drive is organized according to characteristics assigned to each particular instance of media. As a result, anyone accessing the digital set-top box can access any of the media content stored therein. However, at times it may not be desired that all users have access to all of the media content stored in the digital set-top box.

### SUMMARY OF THE INVENTION

It would be advantageous to control access to media content accessible via a digital set-top box in a manner which prevents displaying all of the media content to each user of the digital set-top box. While meeting the above stated need, it would further be advantageous to restrict access to some instances of media accessible via a digital set-top box to a particular user or users.

Embodiments of the present invention recite a method and system for user secure access to user content recordings. This is called a “user-centric” model for the media system. In one embodiment, a particular user who is permitted access to an instance of restricted user-specific media content via a digital set-top box is identified. A user-specific list of media content accessible via the digital set-top box is presented. In embodiments of the present invention, the user-specific list comprises the instance of restricted user-specific media content accessible by the particular user. The particular user is then permitted to access the instance of restricted media via the digital set-top box. Each user has a unique set or media authorized for that user respectively. All users can also access global media recorded onto the system.

As an example, a user of a digital set-top box enters a log-in name and password through a user interface screen. When the identity of the user is confirmed, a user-specific screen provides a list of user-specific media content accessible via the digital set-top box is displayed to that user. In embodiments of the present invention, the list comprises instances of media content (global) which are available to all users of the digital set-top box as well as instances of restricted user-specific media content which are available to authorized users, but not available to all users. In other words, that particular user does not have access to restricted user-specific media content of other users of the digital set-top box. In so doing, embodiments of the present invention control access to the media content accessible via the digital set-top box. This is advantageous in a situation where a parent may wish to be able to, for example, watch a movie which they feel is unsuited for their children to watch due to language, violence, or other objectionable content.

In one embodiment, the user can record the media content while logged in. Subsequently, access to the recorded instance of media content is restricted to that particular user as long as the user is logged-in, the user does not have to re-enter the username/password sequence upon entering the use-specific interface screens. A user can also log-in as a guest and view only the global media content recordings.

In another embodiment of the present invention, a wireless device may be used to remotely access the digital set-top box. A user can insert a removable memory device into the wireless device in order to identify the user to the system and provide user preferences, etc. For example, the removable memory device may store the user's log-in name and password as well as content entitlement information. As a result, the user may directly access the list of content available to that user without using the intervening log-in steps and user password screens described above. In embodiments of the present invention, more than one removable memory device may be inserted into the wireless remote device (e.g., one removable memory device for each of a plurality of users). As a result, the list of media content would display the generally accessible media content as well as the restricted user-specific media content accessible by each of the plurality of users.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary network for distributing media content in accordance with embodiments of the present invention.

FIG. 2 is a block diagram of an exemplary set-top box used for user secure access to user content recordings in accordance with embodiments of the present invention.

FIG. 3 is a block diagram showing components of an exemplary set-top box used for user secure access to user content recordings in accordance with embodiments of the present invention.

FIG. 4A is a flowchart of a method for user secure access to user content recordings in accordance with embodiments of the present invention.

FIG. 4B is a flowchart of a user-centric method for accessing media content in accordance with embodiments of the present invention.

FIG. 5 shows a plurality of exemplary screens displayed in accordance with embodiments of the present invention.

FIG. 6 shows an exemplary remote controller used in accordance with embodiments of the present invention.

### DETAILED DESCRIPTION OF EMBODIMENTS OF THE PRESENT INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

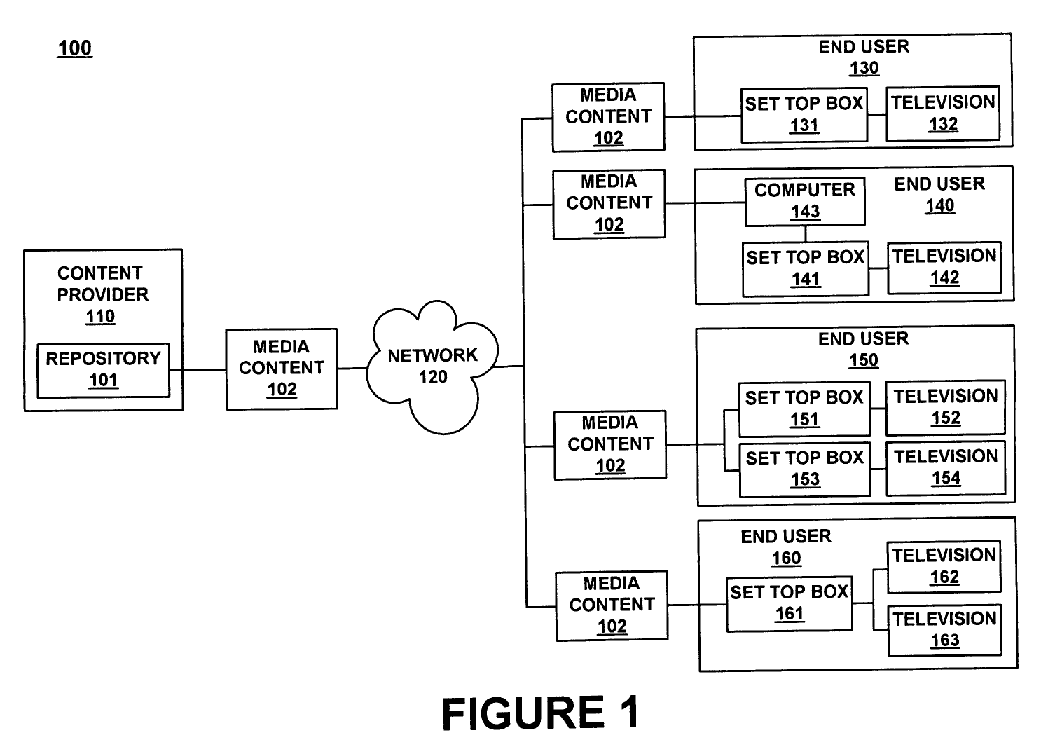

FIG. 1 is a block diagram of an exemplary network for distributing media content in accordance with embodiments of the present invention. In FIG. 1, a content provider 110 distributes media content 102 to a plurality of users (e.g., end users 130, 140, 150, and 160) via network 120. In embodiments of the present invention, media content 102 may comprise any information, e.g., video content (e.g., a television broadcast, a movie, a pay-per-view event, a game, etc.), audio content (e.g., music, a speech, a theatrical performance, etc), an image, or text. Additionally, network 120 may comprise a broadcast network, the Internet, a telephone network, or the like. In embodiments of the present invention, the media content 102 may be distributed as a digitally encoded signal. The signal is received as an input into a set top box (e.g., set top boxes 131, 141, 151, and 161) by each of the end user's, converted into an analog signal, and output, for example, to the end user's television (e.g., televisions 132, 142, 152, 154, 162, and 163). In another embodiment, media content 102 may be distributed as an analog signal.

There are a variety of configurations which may be used by end users to couple a digital set-top box with content provider 110 in embodiments of the present invention. For example, end user 130 has coupled television 132 with network 120 via digital set-top box 131. Other users may couple a personal computer or home gateway device with network 120 and use that as the connection point for other devices. For example, user 140 has coupled a computer 143 between digital set-top box 141 and network 120. Alternatively, end user 150 has coupled a plurality of digital set-top boxes (e.g., digital set-top boxes 151 and 153 with network 120 and coupled each of the digital set-top boxes with a television (e.g., televisions 152 and 154 respectively). In another embodiment, a single digital set-top box may be coupled with a plurality of televisions. For example, digital set-top box 161 is coupled with televisions 162 and 163. It is appreciated that embodiments of the present invention are well suited to be utilized in configurations other than those shown in FIG. 1 as well.

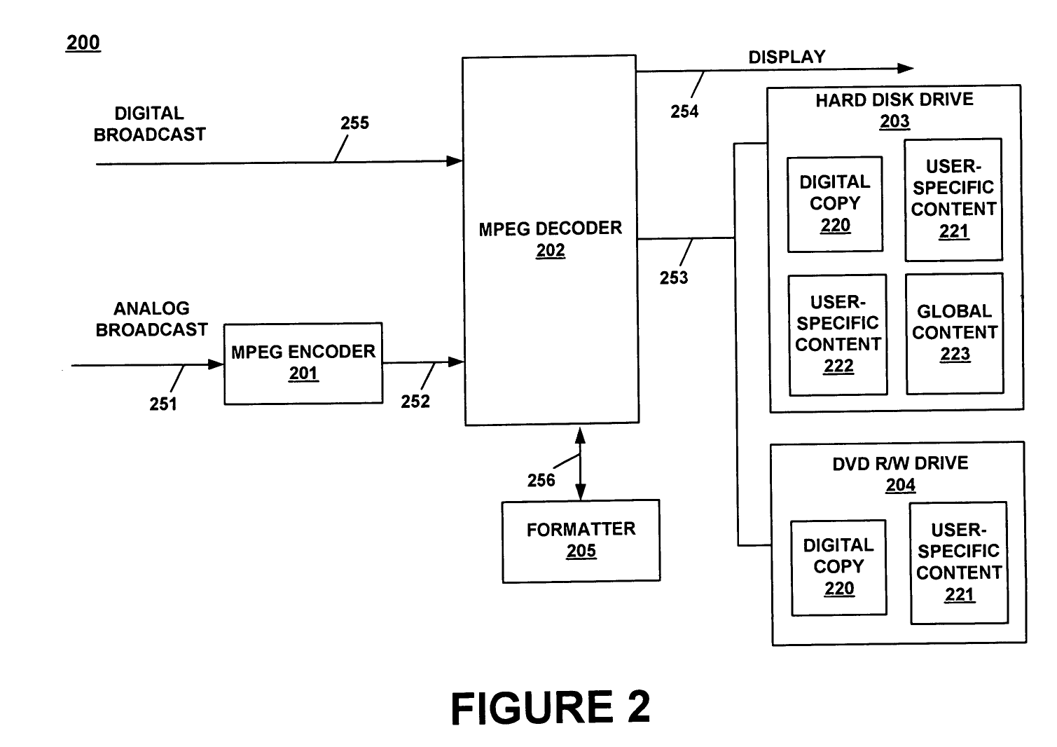

FIG. 2 is a block diagram of an exemplary user-centric system 200 for accessing restricted media content in accordance with embodiments of the present invention. In embodiments of the present invention, system 200 may be implemented as a digital set-top box or any electronic unit as discussed above with reference to FIG. 1 (e.g., digital set-top boxes 131, 141, 151, 153, and 161). In FIG. 2, analog broadcast content (e.g., media content 102 of FIG. 1) is received via coupling 251 into MPEG encoder 201. MPEG encoder 201 converts the analog signal of media content 102 into a digital format in which the data is packetized and sent to MPEG decoder 202 via coupling 252. In one embodiment, MPEG decoder 202 passes through the digital packets in encoded format to hard disk drive 203 via coupling 253 where a digital copy 220 of media content 102 is stored. While the present embodiment teaches storing media content 102 on a hard disk drive, embodiments of the present invention are well suited for storing the digital copy 220 of media content 102 upon a variety of storage media. For example, a digital copy can be stored in a networked storage medium such as a storage area network (SAN) or upon another device communicatively coupled with system 200 (e.g., computer 143 of FIG. 1). Alternatively, a digital copy can be stored via a storage device drive such as a digital versatile disk drive (e.g., DVD R/W drive 204). In another embodiment, a digital copy of media content 102 may be maintained in repository 101 of content provider 110. In embodiments of the present invention, each particular user who has established a user account with system 200 can store user-specific media content which is accessible only by that particular user. For example, in FIG. 2, a first instance of user-specific content 221 is accessible to a first user of system 200 but to no other user. Similarly, a second instance of user-specific content 222 is accessible to a second user of system 200 but not to any other user including the first user of system 200. Global content 223 is accessible to all users of system 200 including the users of user-specific content 221 and user-specific content 222. As shown in FIG. 2, user-specific content can be stored on DVD R/W drive 204 as well as on hard disk drive 203. It is appreciated that the global content (e.g., 223) may also be stored on DVD R/W drive 204.

Embodiments of the present invention use hard drive 203 as temporary storage during real-time viewing to support digital video recorder features such as pause, cue, rewind, etc. For example, to pause the recorder, hard drive 203 continuously spools the data until playback of the media content is resumed. Additionally, storing a digital copy 220 of media content 102 on hard disk drive 203 allows a user to view media content 102 at a later time that is more convenient to the user.

In embodiments of the present invention, when a user wants to access media content 102, hard disk drive 203 is accessed by MPEG decoder 202 wherein the digitally encoded content is decoded and sent via coupling 254 to a display device (e.g., a television). Again, this may be performed in a real-time operation which is substantially concurrent with the receiving of media content 102, or may occur at a later time.

In embodiments of the present invention, media content 102 may also sent be from MPEG decoder 202 to formatter 205 via coupling 256 wherein the broadcast content is converted into a format compatible with a second storage medium. For example, in one embodiment, the broadcast content is converted into a data stream format which facilitates storing media content 102 on a recordable DVD R/W disk. Again, while the present embodiment recites a recordable DVD R/W disk, embodiments of the present invention are well suited for converting media content 102 into a variety of formats. Additionally, formatter 205 may convert media content 102 into more than one format to be compatible with a variety of storage media. In embodiments of the present invention, media content 102 is converted by formatter 205 concurrent with its being displayed by a display device. In embodiments of the present invention, this may occur in real-time as media content 102 is received by system 200 (e.g., via coupling 251). Alternatively, media content 102 may be stored on hard disk drive 203 as the first digital copy 220 and undergo the format conversion by formatter 205 at a later time. In embodiments of the present invention, this is controlled by the user of system 200. For example, a user may first wish to review media content 102 before deciding whether to create the second digital copy, and thus use more storage space of hard disk drive 203.

Additionally, system 200 can also receive a digital broadcast comprising media content 102 via coupling 255 and MPEG decoder 202. In embodiments of the present invention, the digital broadcast may comprise a standard definition (SD) digital broadcast or a high definition (HD) digital broadcast. Typically, digital broadcast content is received as a packetized data stream. The packetized data is passed through MPEG decoder 202 to hard disk drive 203 via coupling 253 wherein a digital copy 220 of media content 102 is stored to support features of the digital video recorder as described above. The broadcast digital data is stored in an encoded MPEG format. When a user wants to access media content 102, hard disk drive 203 is accessed by MPEG decoder 202 via coupling 253 wherein it is decoded and sent to the display device via coupling 254.

As described above, in embodiments of the present invention, media content 102 may also sent to MPEG decoder 202 for decoding and then to formatter 205 via coupling 256 wherein the broadcast content is converted into a format compatible with a second storage medium (e.g., a data stream format). In embodiments of the present invention, the broadcast content is converted by formatter 205 in real-time (e.g., concurrent with its being displayed), or may be stored on hard disk drive 203 and undergo the format conversion by formatter 205 at a later time. The broadcast content undergoes format conversion and is sent through MPEG decoder 202 via coupling 256 and then to hard disk drive 203 wherein a second digital copy of the broadcast content is stored.

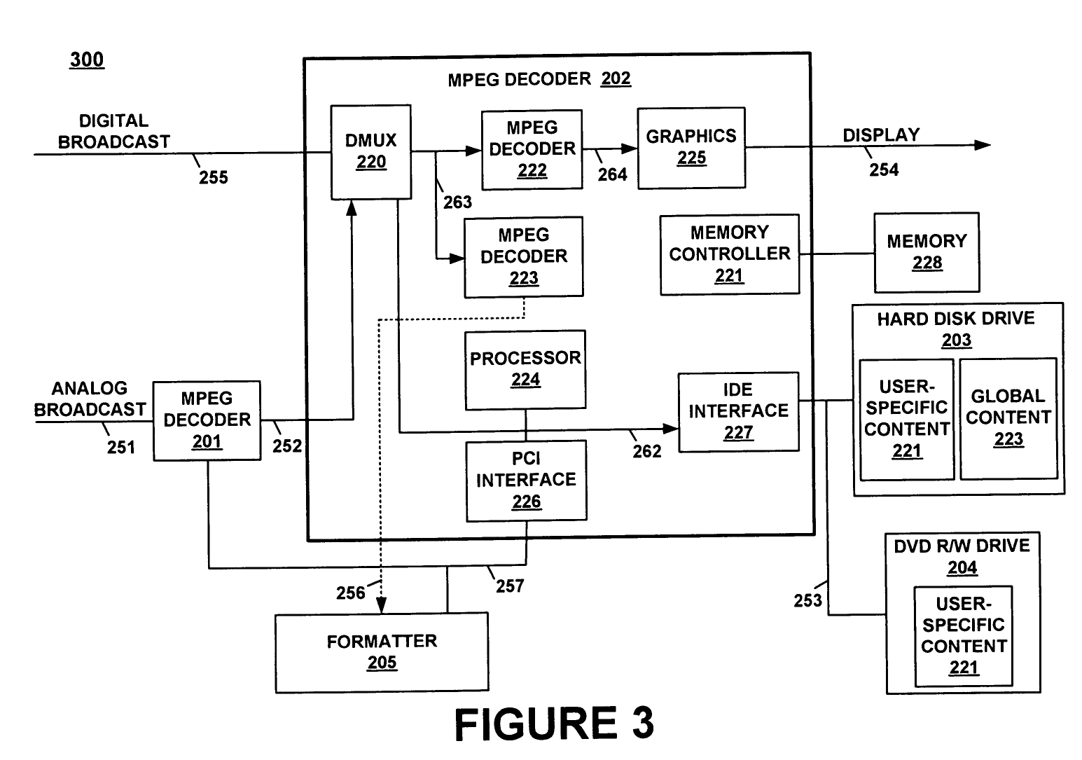

FIG. 3 is a block diagram, showing in greater detail, components of an exemplary MPEG decoder 202 in accordance with embodiments of the present invention. In embodiments of the present invention, MPEG decoder 202 may receive broadcast content that is sent via cable, terrestrial (e.g., radio broadcast), or satellite networks. In the embodiment of FIG. 3, an analog signal conveying media content 102 is received via coupling 251, digitized and encoded to a digital format by MPEG encoder 201 and sent to MPEG decoder 202 via coupling 252. Processor 224 of MPEG decoder 202 controls demux 220 to send recording data to memory 228 via memory controller 221. For clarity, the connections between memory controller 221 and other components of MPEG decoder 202 have been omitted. Processor 224 also controls memory controller to send the packetized data to an IDE interface 227 via bus 262. The packetized data is then sent via coupling 253 to hard disk drive 203 wherein a first digital copy 220 of the encoded MPEG data is stored. If media content 102 is conveyed via a digital signal, it is sent to hard disk drive 203 wherein a digital copy 220 of media content 102 is stored. In embodiments of the present invention, the digital copy 220 of media content 102 may be formatted in a high definition or standard definition format.

In one embodiment, when the media content 102 is accessed for playback, hard disk drive 203 is accessed by MPEG decoder 202 via IDE interface 227 and media content 102 is sent to memory 228 via memory controller 221 and then sent to MPEG decoder 222. In embodiments of the present invention, DVR/PVR controller software processed by processor 224 typically comprises logic for controlling the presentation of the media content 102 by controlling demux 220. For example, a DVR/PVR software controller comprises logic for controlling functions such as playback, pause, cue, rewind, slow-motion play, etc. A PVR/DVR software controller comprises logic for performing the functions of a DVR controller and additional features such as tracking program preferences, recommending programs, etc. In the embodiment of FIG. 3, media content 102 is decoded by MPEG decoder 222 and sent via coupling 264 to a graphics component 225 and then to the display device via coupling 254. In embodiments of the present invention, this process can be performed in real-time, that is, substantially concurrent to receiving the broadcast content. Alternatively, media content 102 can be stored on hard disk drive 203 and accessed for playback at a later time.

In embodiments of the present invention, demux 220 sends the broadcast content to MPEG decoder 223 wherein the broadcast content may be formatted into an interim signal. For example, if the digital broadcast content comprises a high definition digital broadcast, it cannot be stored by a DVD R/W. Therefore, MPEG decoder 223 would first “down decode” the HD broadcast content into a standard definition digital format. In one embodiment, the interim signal from MPEG decoder 223 comprises an analog signal. The interim signal is sent from MPEG decoder 223 to formatter 205 via coupling 256.

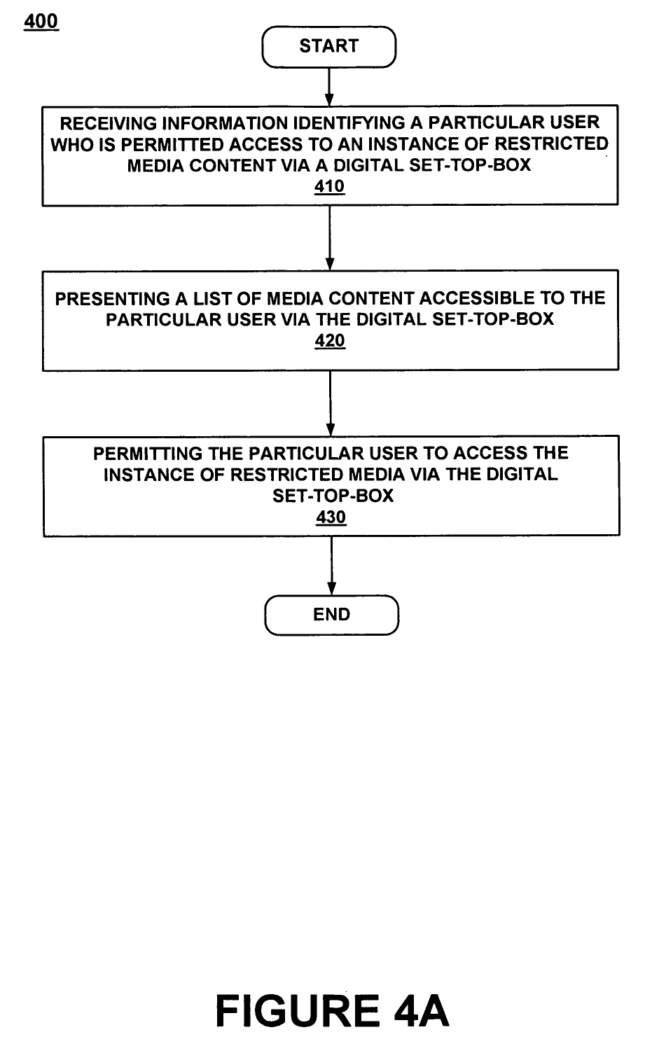

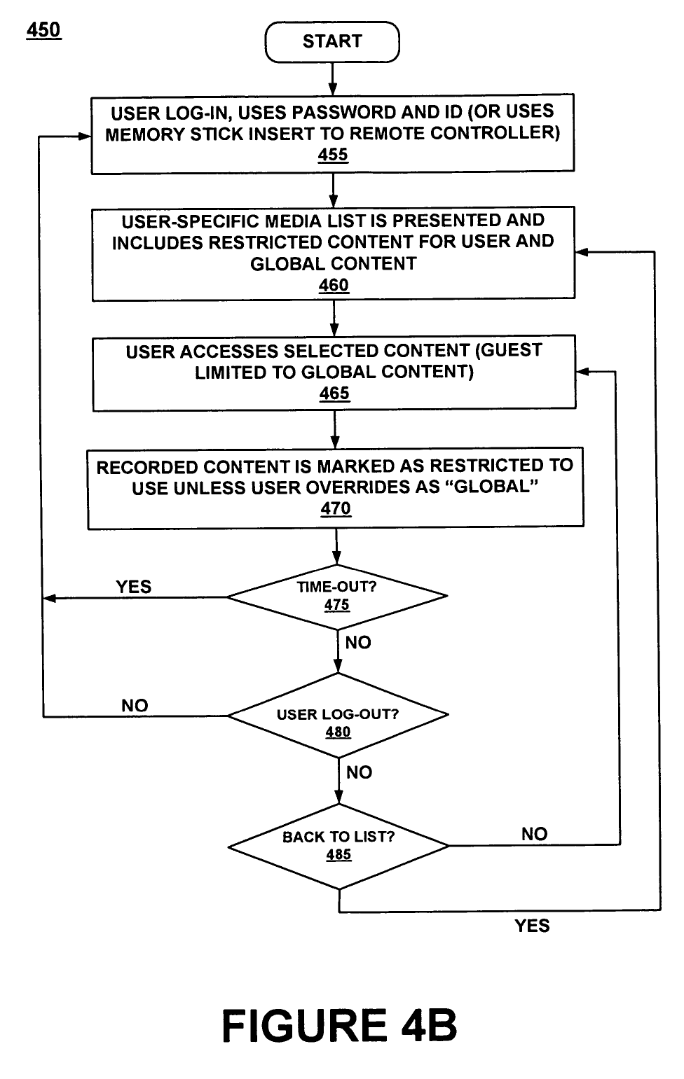

FIG. 4A is a flowchart of a method 400 for digitally recording broadcast content in accordance with embodiments of the present invention. In step 410 of FIG. 4A, information identifying a particular user who is permitted access to an instance of restricted media content via a digital set-top box (e.g., digital set-top box 200 of FIG. 2) is received. In embodiments of the present invention, users of digital set-top box 200 can create an individual user account for that digital set-top box. Upon creating an individual user account, each user can create a list of restricted media content which is accessible only to that particular user. In embodiments of the present invention, a particular user can access his/her list of restricted media content by logging in via user selection procedure.

In embodiments of the present invention, a user can store media content via set-top box 200 for later access. In embodiments of the present invention, when a user is logged in and indicates that he/she would like to record or otherwise store an instance of media content, the user is presented with the option of storing the media content as a generally accessible title. If the user selects this option, the media content will be stored either on digital set-top box 200 (e.g., on hard disk drive 203), or remotely (e.g., in repository 101 of content provider 110). Subsequently, this media content will be accessible to any user of digital set-top box 200 without restriction. However, if the user selects to save the media content to his/her individual user account, the instance of media content will be accessible to users who provide the correct user name and password for accessing that account.

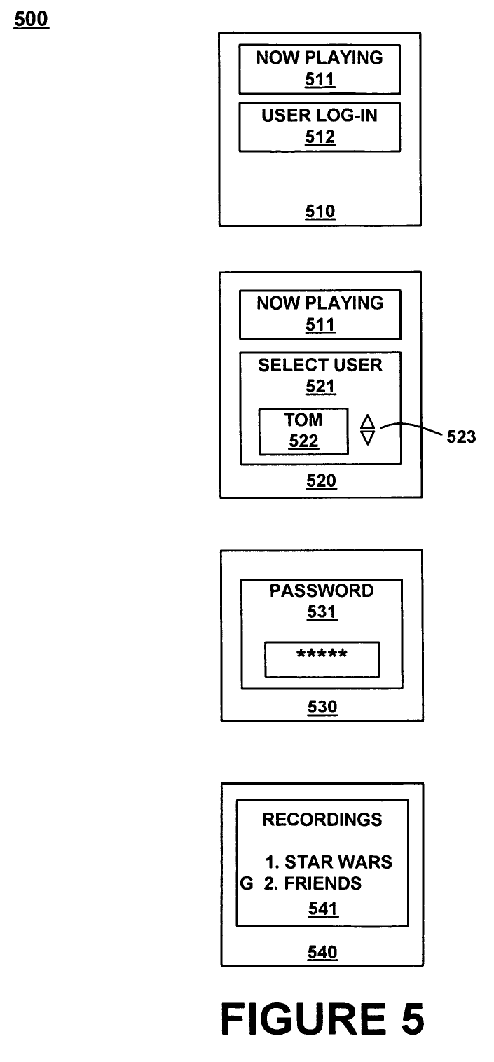

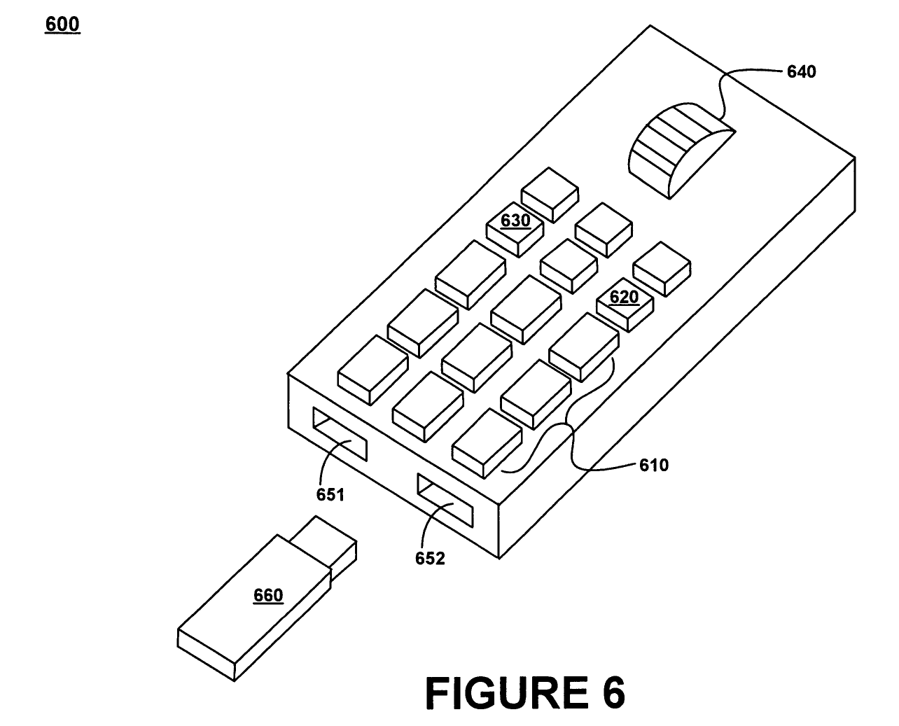

An exemplary user selection mechanism in accordance with embodiments of the present invention is shown in FIG. 5. The exemplary screens shown in FIG. 5 are displayed to a user to facilitate identifying a particular user. For example, a user can initiate the user selection procedure by making an indication via a remote controller (e.g., controller 600 of FIG. 6). In response to the indication, digital set-top box 200 causes screen 510 to be displayed (e.g., on television 132 of FIG. 1). Using the controller, the user can select user log-in sub-screen 512. Alternatively, if a user does not wish to log-in, or has not created an individual user account with the digital set-top box, the user can select sub-screen 511 to access a list of media content which is available to all users of digital set-top box 200 (e.g., the now playing sub-screen 511). In other words, the user is logged in as a guest and cannot access restricted media content via digital set-top box 200. In embodiments of the present invention, restricted media refers to an instance of media which is associated with the individual user account of a particular user of a digital set-top box. It is appreciated that the same instance of restricted media content may be associated with more than one individual user account of a digital set-top box. However, each user accesses the restricted media content via his/her individual user account rather than as a general user or guest user of digital set-top box 200.

In embodiments of the present invention, if a user selects user log-in sub-screen 512 screen 520 is next displayed. In screen 520, a sub-screen 521 is displayed which facilitates selecting a user name of the user logging in. In the embodiment of FIG. 5, sub-screen 521 displays a window 522 in which the name of a registered user of digital set-top box 200 is displayed. The list of registered users can be scrolled through using the scrolling buttons 523 displayed in sub-screen 521 or by using a scrolling device or cursor controller disposed upon controller 600. In embodiments of the present invention, each user logging in to digital set-top box 200 may be required to have a unique user name to, for example, distinguish two users who may have the same name.

In embodiments of the present invention, upon selecting a user name, screen 530 is displayed. In screen 530, a sub-screen 531 is displayed which allows a user to enter a password which is associated with that particular user. In embodiments of the present invention, the user name and password entered by the user attempting to log-in are compared with a user name and password stored, for example, on hard disk drive 203, or memory 228 of digital set-top box 200. In another embodiment, the user name and password may be stored remotely (e.g., in repository 101 of FIG. 1). In embodiments of the present invention, if the user name and password match the stored user name and password, a particular user of digital set-top box 200 is identified.

In step 420 of FIG. 4A, a list is presented of media content accessible to the particular user via digital set-top box 200 which includes a list of restricted media content accessible by that particular user. Referring again to FIG. 5, upon successfully logging in, screen 540 is displayed to the user. A sub-screen 541 of screen 540 comprises a list of media content which the user may access via digital set-top box 200. In embodiments of the present invention, the list includes restricted media for that user as well as global content accessible to all users. In the exemplary sub-screen 541, the titles of two instances of media content are listed (e.g., “Star Wars” and “Friends”). In the margin adjacent to one of the titles, the letter “G” is also displayed. This may indicate to the user that the title is a generally accessible instance of media content. It is appreciated that there are a variety of ways of indicating whether an instance of media content is generally accessible for all users or an instance of restricted media content in embodiments of the present invention. In embodiments of the present invention, when a user has logged in to set-top box 200, the user may also be automatically logged in with other devices communicatively coupled with set-top box 200 (e.g., with computer 143 of FIG. 1).

In step 430 of FIG. 4A, the particular user is permitted to access the instance of restricted media via the digital set-top box. In embodiments of the present invention, the user can scroll down the list of media content titles and select a title which the user would like to access. For example, a user may use the select button of controller 600 to select a title in the list which is highlighted. In response, digital set-top box 200 initiates accessing the selected media content for presentation to the user. In embodiments of the present invention, the selected media content may comprise the restricted media content displayed on a particular user's list of media content.

In embodiments of the present invention, at least one user of digital set-top box 200 may be designated as the system administrator of that digital set-top box. In embodiments of the present invention, that user can access system functions of digital set-top box 200 such as hard disk drive maintenance (e.g., deleting media content, editing user accounts and user definitions, etc.). However, the system administrator may not access information related to the other user's content such as the titles or other descriptions of restricted media content stored in each user's account. Instead, a generic ID shall be used during system maintenance. In another embodiment, the system administrator may override this function to permit, for example, a parent to view titles stored by his/her children.

In embodiments of the present invention, a user may log-out from digital set-top box 200 using, for example, a button or log-out key sequence of controller 600. Alternatively, upon logging in, a timeout sequence may be initiated by digital set-top box 200. At the end of the timeout sequence, the user is automatically logged out of his/her individual user account and logged in as a guest of digital set-top box 200. This prevents a user from forgetting to log-out, thus allowing other users to view the titles of restricted media content in an account and possibly access media content which may be unsuitable.

FIG. 4B is a flowchart of a user-centric method 450 for accessing media content in accordance with embodiments of the present invention. At step 455 of method 450, user log-in is performed. It is assumed that system 200 permits guest user privileges to all users until a particular user is identified using a log-in process. When a user wants to access restricted media content via system 200, the user can utilize the user selection mechanism described above with reference to FIG. 5. In embodiments of the present invention, the user enters a username and password to identify the particular user logging into system 200.

In step 460 of method 450, a user-specific media list is presented. In response to identifying the particular user accessing system 200, a user-specific list is presented which includes the restricted media content that is specific to that user. The list (e.g., sub-screen 541 of FIG. 5) also includes the global media content that is accessible to all users of system 200. In embodiments of the present invention, the list of media can include media content that is stored upon system 200 as well as media content available from a content provider. It is appreciated that the list may comprise instances of media content that are being received in real time from content provider 110.

In step 465 of method 450, the user accesses selected content. In embodiments of the present invention, the user may scroll down the list displayed in step 460 to identify a particular instance of media content and indicate that the instance of media content has been selected.

In step 470 of method 450, the user elects to record the media content and the content is marked as restricted. In embodiments of the present invention, the user may choose to record an instance of media content. In embodiments of the present invention, when a user is logged in, the recorded media content will be associated with that particular user. As a result, later access of that instance of media content is restricted to the user that recorded it. However, the user can override this function by marking the instance of media content as global content. It is appreciated that the user may mark the instance of media content as global before, during, or after the media content has been recorded.

In step 475 of method 450, a logical operation is performed to determine whether a pre-determined time period has elapsed. In embodiments of the present invention, a logged in user is automatically logged out when a pre-determined time period has elapsed. This prevents other users of system 200 from accessing the restricted media content of the logged in user if, for example, that user forgets to log out. In embodiments of the present invention, the time period can be determined by each individual user, or by the system administrator of system 200. If the pre-determined time period has elapsed, method 450 returns to step 455 and the user may log in again if so desired.

In step 480 of method 450, a logical operation is performed to determine whether the user has logged out. If the pre-determined time period has not elapsed, system 200 determines whether the user has logged out. If the user has logged out, method 450 returns to step 455. As a result, users will again access system 200 with guest access privileges until another user logs in. If the user has not logged out, method 450 continues to step 485.

In step 485 of method 450, a logical operation is performed to determine whether the user wants to return back to the user-specific media list. In embodiments of the present invention, a user can cause user selection mechanism 500 to be displayed (e.g., using remote controller 600 of FIG. 6). As a result, method 450 returns to step 460. In embodiments of the present invention, when a user is logged in, the user can cause sub-screen 541 to be displayed, thus allowing the user to select a new instance of media content. If the user does not select returning to the list, method 450 returns to step 465 and the user can continue accessing selected content via system 200.

FIG. 6 shows an exemplary remote controller 600 used in accordance with embodiments of the present invention. In FIG. 6, a plurality of buttons 610 are used for input functions typically found in a television and/or video recorder controller (e.g., channel selection, rewind, fast forward, pause, play, stop, record, etc.) Other buttons which may be included with controller 600 include a select button 620 for indicating the selection of an option displayed upon a television (e.g., to select user log-in sub-screen 512 of FIG. 5). Log-out button 630 is provided to quickly facilitate logging a user from his/her individual user account. Also shown is a jog-dial 640 which can, for example, be used to control a cursor, or to fast forward or rewind a recorded instance of media content. While the present embodiment shows a jog-dial, embodiments of the present invention may utilize a variety of user input devices such as a joystick, a trackball, cursor control buttons, etc. In embodiments of the present invention, controller 600 is wirelessly coupled with set-top box 200 via an infrared or radio component (not shown).

Also shown in FIG. 6 are ports 651 and 652 into which a removable memory device (e.g., a universal serial bus (USB) memory stick) may be inserted. It is appreciated that a variety of removable memory devices may be used in accordance with embodiments of the present invention. Using the removable memory device, a user can store content entitlement information such as the user name and password associated with his/her individual user account and user preferences. In so doing, the user can skip the log-in process described above with reference to FIG. 4. For example, in response to receiving an indication of an insertion event of removable memory device 660, controller 600 may access a file stored thereon which contains the user name and password of the user logging into set-top box 200. The user is then identified as described above with reference to FIG. 4. Removable memory device 660 may also store other information such as user preferences and/or media content entitlement information. In embodiments of the present invention, when removable memory device 660 is removed from controller 600, the memory device remove event will initiate an automatic user log-out procedure for that user.

In embodiments of the present invention, a plurality of users may log-in simultaneously by inserting their respective memory devices into controller 600 (e.g., into ports 651 and 652). In embodiments of the present invention, when more than one user is logged in to set-top box 200, the titles of restricted media content accessible by both users, as well as the media content generally accessible to guest users, will be displayed (e.g., on screen 540 of FIG. 5).

Embodiments of the present invention are advantageous because they allow greater control of access to media content which may not be suitable for all users of the set-top box.

The preferred embodiment of the present invention, a method and system for user secure access to user content recordings, is thus described. While the present invention has been described in particular embodiments, it should be appreciated that the present invention should not be construed as limited by such embodiments, but rather construed according to the following claims.

What is claimed is:

1. A method for user secure access to user content recordings comprising:
receiving information identifying a first particular user who is permitted access to an instance of restricted media content via a digital set-top box;
presenting a list of media content accessible by said first particular user via said digital set-top box and wherein said list comprises said instance of restricted user-specific media content; and
permitting said first particular user to access said instance of restricted user-specific media content via a selection controlled by said digital set-top box.

2. The method as recited in claim 1 wherein said presenting a list comprises:
presenting a list of media content accessible via said digital set-top box which is accessible to a plurality of users without restriction.

3. The method as recited in claim 1 further comprising:
automatically performing a log-out procedure for said first particular user when a pre-defined period of time has elapsed.

4. The method as recited in claim 1 wherein said receiving information identifying said first particular user comprises:
utilizing a wireless device to access said digital set-top box;
receiving a notification of an insertion event of a memory device into said wireless device; and
accessing data disposed upon said memory device identifying said first particular user.

5. The method as recited in claim 4 further comprising:
receiving a notification of a second insertion event of a second memory device into said wireless device;
accessing data disposed upon said second memory device identifying a second particular user; and
modifying said list of media content accessible via said digital set-top box wherein said list comprises said instance of restricted user-specific media content accessible to said first particular user and an instance of restricted user-specific media content accessible to said second particular user.

6. The method as recited in claim 4 further comprising:
notifying a plurality of devices communicatively coupled with said digital set-top box in response to receiving said notification of said insertion event.

7. The method as recited in claim 4 further comprising:
receiving a notification of a remove event of said memory device from said wireless device;
automatically logging off said first particular user; and
modifying said list of media content wherein said instance of restricted user-specific media is no longer displayed.

8. The method as recited in claim 1 further comprising:
storing an instance of media content wherein access to said instance of media content is performed via said digital set-top box;
indicating that said instance of media content comprises a second instance of restricted user-specific media content; and
modifying said list of media content to display said second instance of restricted user-specific media content.

9. A digital set-top box system comprising:
a bus;
a memory device coupled with said bus; and
a processor coupled with said bus, said processor for implementing a method of accessing restricted user-specific media content, said method comprising:
receiving information identifying a first particular user who is permitted access to an instance of restricted user-specific media content via said digital set-top box;
presenting a user-specific list of media content accessible by said first particular user via said digital set-top box and wherein said list comprises said instance of restricted user-specific media content; and
permitting said first particular user to access said instance of restricted user-specific media content via said digital set-top box.

10. The system of claim 9 wherein said method further comprises:
presenting a list of media content accessible via said digital set-top box which is accessible to a plurality of users without restriction.

11. The system of claim 9 wherein said digital set-top box automatically performs a log-out procedure for said first particular user when a pre-defined period of time has elapsed.

12. The system of claim 9 further comprising a wireless device communicatively coupled with said digital set-top box, and wherein said receiving information identifying said first particular user comprises:
receiving a notification of an insertion event of a memory device into said wireless device; and
accessing data disposed upon said memory device identifying said first particular user.

13. The system of claim 12 wherein said method further comprises:
receiving a notification of a second insertion event of a second memory device into said wireless device;
accessing data disposed upon said second memory device identifying a second particular user; and
modifying said user-specific list of media content accessible via said digital set-top box wherein said list comprises said instance of restricted user-specific media content accessible to said first particular user and an instance of restricted user-specific media content accessible to said second particular user.

14. The system of claim 12 further comprising a plurality of devices communicatively coupled with said digital set-top box and wherein said plurality of devices are notified of said insertion event.

15. The system of claim 12 wherein said method further comprises:
receiving a notification of a remove event of said memory device from said wireless device;
automatically logging off said particular user; and
modifying said user-specific list of media content wherein said instance of restricted media is no longer displayed.

16. The system of claim 9 wherein said method further comprises:
storing an instance of media content wherein access to said instance of media content is performed via said digital set-top box;
indicating that said instance of media content comprises a second instance of restricted user-specific media content; and
modifying said user-specific list of media content to display said second instance of restricted user-specific media content.

17. A set-top-box controlled method of providing access to stored media content, said method comprising:
storing media content on a digital storage media wherein access to respective portions of said media content is restricted to specific authorized users;
authorizing a first user;
presenting on a display screen a user-specific listing of media content accessible to said first user wherein said user-specific listing comprises an instance of restricted media content; and
providing access to said instance of restricted media content for said first user in response to a user selection thereof.

18. A method as described in claim 17 wherein said user-specific listing further comprises a listing of media content accessible by any user.

19. A method as described in claim 17 further comprising:
authorizing a second user;
presenting on said display screen a user-specific listing of media content accessible to said second user wherein said user-specific listing comprises an instance of restricted media content; and
providing access to said instance of restricted media content for said second user in response to a user selection thereof.

20. A method as described in claim 17 wherein said authorizing said first user comprises said first user entering a password and user identification information onto a user interface screen.

21. A method as described in claim 17 wherein said authorizing said first user comprises said first user supplying authorization information to said set-top-box via a wireless remote device.

22. A method as described in claim 17 further comprising logging off said first user in response to a predetermined elapsed time.

23. A method as described in claim 17 further comprising recording an instance of media content as restricted to said first user in response to said first user recording said instance of media content while being authorized.
